(19) United States
(12) Patent Application Publication
(10) Pub. No.: US 2024/0397927 A1
(43) Pub. Date: Dec. 5, 2024

(54) PLANT WITHERING/KILLING METHOD AND PLANT WITHERING/KILLING SYSTEM

(71) Applicant: Ushio Denki Kabushiki Kaisha, Tokyo (JP)

(72) Inventor: Keisuke NAITO, Tokyo (JP)

(73) Assignee: Ushio Denki Kabushiki Kaisha, Tokyo (JP)

(21) Appl. No.: 18/698,121

(22) PCT Filed: Aug. 18, 2022
(86) PCT No.: PCT/JP2022/031145

§ 371 Date: Apr. 3, 2024

(30) Foreign Application Priority Data
Oct. 4, 2021 (JP) 2021-163535

(51) Int. Cl. A01M 21/00

(52) U.S. Cl. CPC A01M 21/00

(57) ABSTRACT

Provided are a plant withering/killing method and a plant withering/killing system that are capable of reliably withering/killing a plant by using ultraviolet rays. A plant withering/killing method includes a process of applying ultraviolet rays to a plant from an ultraviolet light source, the ultraviolet rays having a peak wavelength within a wavelength range of 200 nm to 280 nm, wherein the process of applying the ultraviolet rays is performed in a darkened environment.

### TECHNICAL FIELD

The present invention relates to a plant withering/killing method and a plant withering/killing system.

### BACKGROUND ART

The present applicant has conventionally considered a technique for using ultraviolet rays for withering/killing or growth control of plants (for example, Patent Document 1 described below). It is also known that ultraviolet rays to be used have a wavelength of 200 nm to 280 nm. The use of ultraviolet rays within this range enables plants to be effectively withered/killed, for example.

### PRIOR ART DOCUMENT

### Patent Document

Patent Document 1: JP-A-2016-73230

### SUMMARY OF THE INVENTION

### Problems to be Solved by the Invention

However, Patent Document 1 does not consider at all an environment at the time of applying ultraviolet rays for the purpose of withering/killing plants. Stated another way, in the method of Patent Document 1, it is assumed that ultraviolet rays are normally applied in a bright (daytime) environment. In other words, according to this method, ultraviolet rays are also applied to plants in a state where visible light is applied to the plants.

In a case where visible light is applied to plants, that is, in an environment where photosynthesis is advancing, energy is delivered to nicotinamide dinucleotide phosphate (NAPD⁺), active oxygen that causes the plants to be withered/killed is prevented from being generated, and the plants wither at slow speed or the plants do not wither in some cases.

The present invention has been made in view of the problems described above, and it is an object of the present invention to provide a plant withering/killing method and a plant withering/killing system that are capable of reliably withering/killing a plant by using ultraviolet rays.

### Means for Solving the Problems

A plant withering/killing method according to the present invention includes a process of applying ultraviolet rays to a plant from an ultraviolet light source, the ultraviolet rays having a peak wavelength within a wavelength range of 200 nm to 280 nm, and the process of applying the ultraviolet rays is performed in a darkened environment.

By employing this configuration, the ultraviolet rays having a peak wavelength within a wavelength range of 200 nm to 280 nm are applied to the plant in the darkened environment, and therefore these ultraviolet rays can reliably wither/kill the plant. Note that herein, the “darkened environment” refers to an environment in which the irradiance of visible light is less than 100 lx.

Furthermore, in the plant withering/killing method according to the present invention, the process of applying the ultraviolet rays may be performed in the nighttime. In the nighttime, the ultraviolet rays can be easily applied in the darkened environment.

Furthermore, in the plant withering/killing method according to the present invention, the process of applying the ultraviolet rays may be performed in a state where the plant is covered with a light shielding means. By covering the plant with the light shielding means, the darkened environment can be appropriately achieved.

Furthermore, in the plant withering/killing method according to the present invention, the process of applying the ultraviolet rays may be performed when a detection unit that enables visible light to be detected has not detected application of the visible light. By employing this configuration, the ultraviolet rays can be applied in the darkened environment in which the visible light is not applied.

Furthermore, in the plant withering/killing method according to the present invention, the ultraviolet light source may include a clock unit that detects the current time, and the process of applying the ultraviolet rays may be performed when the current time detected by the clock unit is a time zone of nighttime.

By employing this configuration, the ultraviolet rays can be reliably applied in the time zone of the nighttime in which the darkened environment is kept.

Furthermore, in the plant withering/killing method according to the present invention, the ultraviolet light source may be mounted inside the light shielding means. By employing this configuration, the ultraviolet rays can be applied in a state where the light shielding means appropriately achieves the darkened environment.

Furthermore, in the plant withering/killing method according to the present invention, the light shielding means may include a float that floats on the water surface. By employing this configuration, plants that have propagated in a pond, a lake, or the like can be easily covered with the light shielding means.

Furthermore, in the plant withering/killing method according to the present invention, the ultraviolet light source may include a float that floats on the water surface. By employing this configuration, the ultraviolet light source can be disposed near plants that have propagated in the pond, the lake, or the like. Therefore, ultraviolet rays having high irradiance can be applied to the plants, and a withering/killing effect is highly exhibited.

A plant withering/killing system according to the present invention includes:
an ultraviolet light source that applies ultraviolet rays having a peak wavelength within a wavelength range of 200 nm to 280 nm; and
a controller that controls the ultraviolet light source to apply the ultraviolet rays to a plant in a darkened environment.

By employing this configuration, the ultraviolet rays having a peak wavelength within a wavelength range of 200 nm to 280 nm are applied to the plant in the darkened environment, and therefore these ultraviolet rays can reliably wither/kill the plant.

### BRIEF DESCRIPTION OF THE DRAWINGS

FIG. 1 is a diagram schematically illustrating an example of a situation where a plant withering/killing method according to the present invention is performed.

FIG. 2 is a schematic sectional view illustrating an example of an ultraviolet light source.

FIG. 3 illustrates an example of an emission spectrum of an excimer lamp in which light-emitting gas contains KrCl.

FIG. 4 is a block diagram schematically illustrating an example of a configuration of the ultraviolet light source.

FIG. 5 is a block diagram schematically illustrating another example of the configuration of the ultraviolet light source.

FIG. 6A is a plan view schematically illustrating another example of the situation where the plant withering/killing method according to the present invention is performed.

FIG. 6B is a sectional view schematically illustrating the other example of the situation where the plant withering/killing method according to the present invention is performed.

FIG. 7 is a diagram schematically illustrating yet another example of the situation where the plant withering/killing method according to the present invention is performed.

FIG. 8 is a diagram schematically illustrating yet another example of the situation where the plant withering/killing method according to the present invention is performed.

### MODE FOR CARRYING OUT THE INVENTION

Embodiments of a plant withering/killing method according to the present invention will be described with reference to the drawings. Note that the respective drawings described below are schematic illustrations, dimensional ratios in the drawings do not necessarily coincide with actual dimensional ratios, and the dimensional ratios do not necessarily coincide between the respective drawings.

### First Embodiment

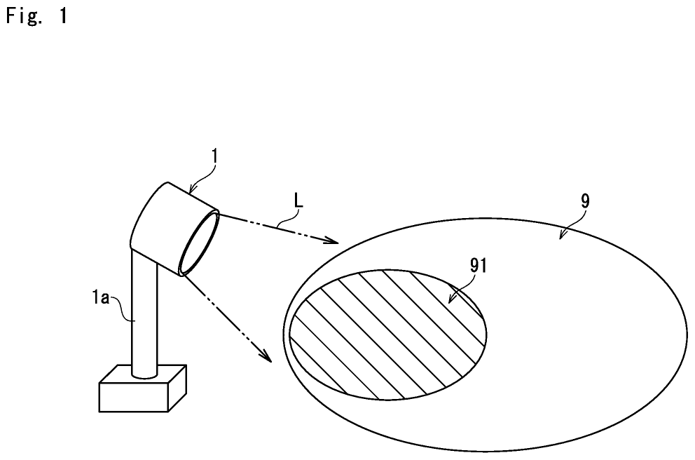

FIG. 1 is a diagram schematically illustrating an example of a situation where the plant withering/killing method according to the present invention is performed. The example illustrated in FIG. 1 indicates a situation where ultraviolet rays are applied to plants that have propagated in a pond 9 and the plants are withered/killed.

In recent years, a foreign species of plant (for example, Alternanthera philoxeroides) has abnormally propagated in ponds or lakes, and there are concerns about an adverse effect on crops or the ecosystem. Therefore, a method for covering the foreign species of plant with a light shielding sheet, hindering photosynthesis, and getting rid of the foreign species of plant has been tried. However, the method for covering the foreign species of plant with the light shielding sheet and getting rid of the foreign species of plant has a problem in which it takes a long period of time (one year or more depending on the environment) to wither the plant. In contrast, the present invention enables the plant to be gotten rid of in a short period of time. Hereinafter, specific methods of the plant withering/killing method and a plant withering/killing system according to the present invention, and their effects are described.

On a water surface of the pond 9, a plant presence area 91, which is an area where a plant has propagated, is present. Ultraviolet rays L are applied to the plant presence area 91 from an ultraviolet light source 1. The ultraviolet light source 1 is installed at an upper end of a pole 1a that has been erected in the vicinity of the pond 9.

The ultraviolet light source 1 is configured to emit ultraviolet rays L having a peak wavelength within a wavelength range of 200 nm to 280 nm. The use of the ultraviolet rays L within this range enables plants to be effectively withered/killed. It is preferable that the ultraviolet light source 1 be configured to emit ultraviolet rays L having a peak wavelength within a wavelength range of 200 nm to 240 nm. Ultraviolet rays L having a shorter wavelength are more effective to wither/kill plants. It is guessed that this is because a component, such as chlorophyll, that contributes to photosynthesis of plants more easily absorbs ultraviolet rays having a shorter wavelength, and the component is more easily destroyed by the ultraviolet rays. Furthermore, ultraviolet rays having a peak wavelength within a wavelength range of 200 nm to 240 nm are safe for humans, and therefore the ultraviolet rays are easily usable even in an environment where a person is present.

As an example, the ultraviolet light source 1 is constituted by an excimer lamp. The excimer lamp includes a discharge vessel that is filled with light-emitting gas. The light-emitting gas is made of a material that emits ultraviolet rays L having a main emission wavelength of 190 nm to 240 nm at the time of excimer emission. As an example, the light-emitting gas contains KrCl, KrBr, or ArF.

For example, in a case where the light-emitting gas contains KrCl, the excimer lamp emits ultraviolet rays L having a peak wavelength of 222 nm or near 222 nm. In a case where the light-emitting gas contains KrBr, the excimer lamp emits ultraviolet rays L having a peak wavelength of 207 nm or near 207 nm. In a case where the light-emitting gas contains ArF, the excimer lamp emits ultraviolet rays L having a peak wavelength of 193 nm or near 193 nm.

Note that herein, the “peak wavelength” refers to a wavelength at which light intensity has a maximum value in an emission spectrum. Furthermore, herein, the “main emission wavelength” refers to a wavelength at which light intensity is 50% or more of a light intensity at the peak wavelength in the emission spectrum.

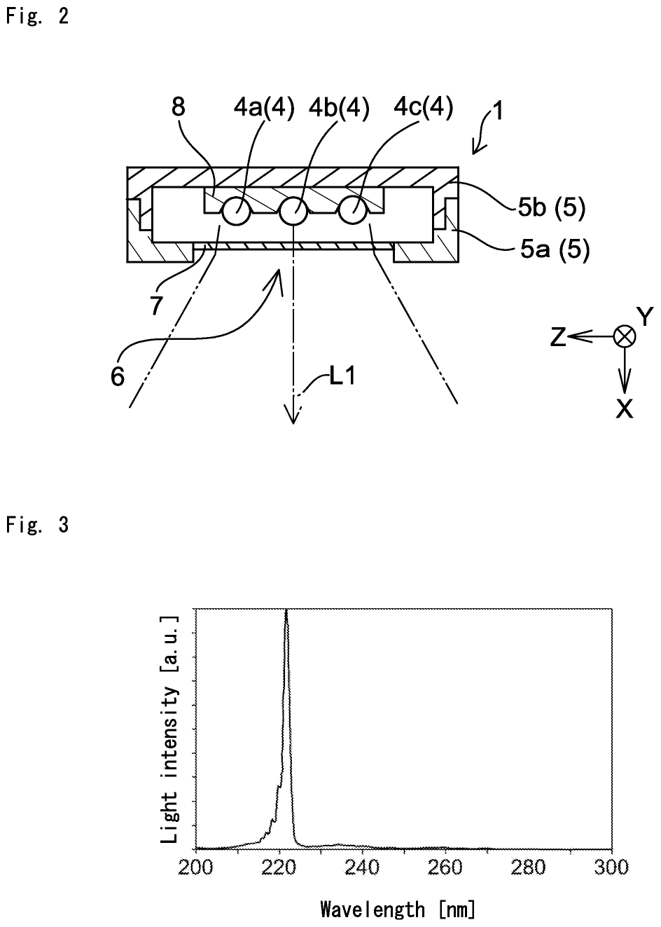

FIG. 2 is a schematic sectional view illustrating an example of the ultraviolet light source 1. Hereinafter, the description of FIG. 2 is provided referring to an XYZ coordinate system as appropriate. In the XYZ coordinate system, it is assumed that a traveling direction of a ray of light on an optical axis of emitted ultraviolet rays is a +X direction, and a plane that is orthogonal to an X direction is a YZ plane. Note that herein, in describing directions, in the case of distinguishing between positive and negative directions, the directions are described with a positive or negative sign added, such as the “+X direction” or a “−X direction”. In a case where a direction is expressed without distinguishing between positive and negative directions, the direction is simply described as an “X direction”. Stated another way, herein, in a case where a direction is simply described as the “X direction”, both the “+X direction” and the “−X direction” are included. The similar is applied to a Y direction and a Z direction.

The ultraviolet light source 1 according to the present embodiment includes an excimer lamp 4 that emits ultraviolet rays, a housing 5 that houses the excimer lamp 4, an extraction portion 6 that extracts the ultraviolet rays emitted from the excimer lamp 4 to the outside of the housing 5 in the +X direction, and an optical filter 7. In FIG. 2, arrow L1 indicates an optical axis of the ultraviolet rays emitted from the excimer lamp 4 and a traveling direction of a ray of light on the optical axis.

In the present embodiment, the housing 5 is constituted by a first frame 5a that includes an opening serving as the extraction portion 6 in the center, and a second frame 5b that does not include an opening, and the second frame 5b and the first frame 5a are fitted into each other to form an internal space that is surrounded by the housing 5. In this internal space, the excimer lamp 4 and two electrode blocks 8, 8 that supply power to the excimer lamp 4 are disposed.

The two electrode blocks 8, 8 are disposed to be spaced apart from each other in the Y direction, and are fixed to a face that is in contact with the internal space in the second frame 5b. The two electrode blocks 8, 8 are made of a conductive material (for example, Al, an Al alloy, stainless steel, or the like).

In the present embodiment, as the excimer lamp 4, three excimer lamps 4 (4a, 4b, 4c) that are disposed to be spaced apart from each other in the Z direction are included. The two electrode blocks 8, 8 are in contact with an outer surface of a light-emitting tube of each of the excimer lamps 4 (4a, 4b, 4c). This causes power to be supplied to the excimer lamps 4, and the excimer lamps 4 light up.

In the present embodiment, as the excimer lamps 4, a KrCl excimer lamp including a light-emitting tube that is filled with light-emitting gas containing KrCl is used.

In the ultraviolet light source 1 according to the present embodiment, the optical filter 7 is disposed in the opening that constitutes the extraction portion 6. Note that to “be disposed in an extraction portion” includes a case where the optical filter 7 is disposed completely integrally with a light extraction face, and also includes a case where the optical filter 7 is disposed in a position that is spaced apart from the light extraction face by a minute distance (for example, several mm to more than ten mm) in the X direction.

Light of a specified wavelength band that has been emitted from the excimer lamp 4 is blocked by the optical filter 7.

The optical filter 7 functions as a bandpass filter that blocks ultraviolet rays of a specified wavelength band, that is, a bandpass filter that does not substantially transmit the ultraviolet rays of the specified wavelength band. For example, in the case of the KrCl excimer lamp, as illustrated in FIG. 3, in a spectrum of the emitted ultraviolet rays, a light output is roughly concentrating near 222 nm, which is a main peak wavelength. However, a light output is also observed for ultraviolet rays of a wavelength band of 240 nm or more and 280 nm or less, which has a possibility of affecting the human body, although this light output is very small. In the present embodiment, the optical filter 7 is provided in an area that forms the extraction portion 6, and therefore ultraviolet rays having a wavelength of 240 nm or more and 280 nm or less are not substantially transmitted, and ultraviolet rays having a wavelength of 200 nm or more and 240 nm or less, which are considered to be safe for humans, are transmitted. This reliably avoids the leakage of ultraviolet rays of a wavelength band that has a possibility of affecting the human body to the outside of the housing 5, and therefore the safety of the ultraviolet light source 1 with respect to the human body is further improved.

It is sufficient if the optical filter 7 has an aspect that functions as a bandpass filter that blocks ultraviolet rays of a specified wavelength band, and a disposition place or a form is not limited. For example, the optical filter 7 may be formed to be in contact with a light source, or may be formed to be spaced apart from the light source.

However, the form of the ultraviolet light source 1 is not limited if the ultraviolet light source 1 is configured to emit ultraviolet rays having a peak wavelength within a wavelength range of 200 nm to 280 nm. Stated another way, the ultraviolet light source 1 may be constituted by a solid-state light source, such as an LED or a laser diode, instead of the excimer lamp.

As described above, in an environment where visible light is applied to plants and photosynthesis is advancing, even if ultraviolet rays are applied to the plants, the plants wither at slow speed, or do not wither in some cases. The present inventor has progressed the study of the plant withering/killing method, and has discovered that plants can be reliably withered/killed by applying ultraviolet rays L to the plants in a dark environment (a darkened environment).

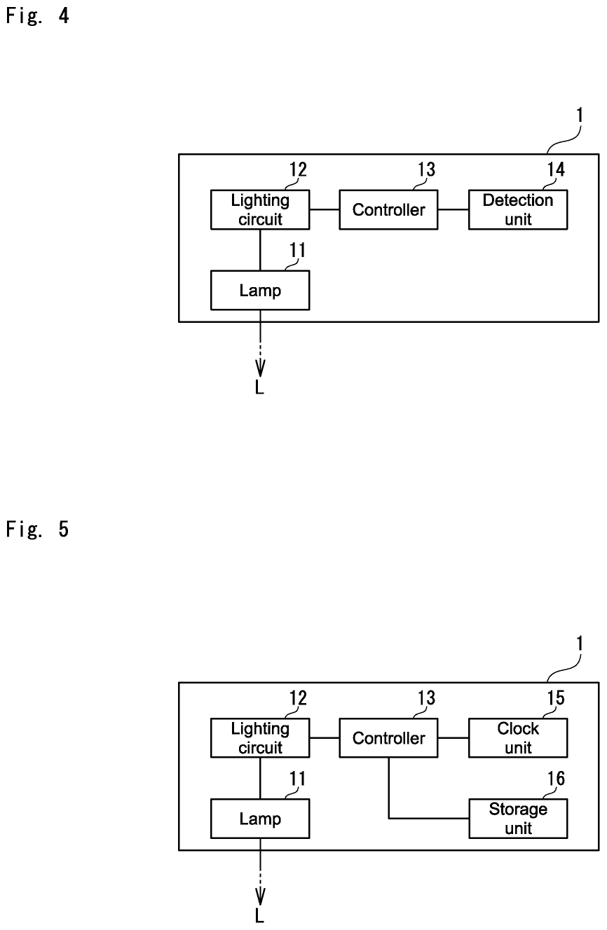

In order to apply ultraviolet rays L in the darkened environment, in the present embodiment, the ultraviolet rays L are applied when visible light is not applied. FIG. 4 is a block diagram schematically illustrating an example of a configuration of the ultraviolet light source 1. As illustrated in FIG. 4, the ultraviolet light source 1 includes a lamp 11 that emits the ultraviolet rays L, a lighting circuit 12 that supplies the lamp 11 with power required for lighting, and a controller 13 that is configured to adjust a current or a voltage to be supplied to the lamp 11. In the example illustrated in FIG. 4, the ultraviolet light source 1 further includes a detection unit 14 that can detect visible light.

The controller 13 controls lighting/lighting-out of the lamp 11 on the basis of a signal from the detection unit 14. Specifically, when the controller 13 has received a signal from the detection unit 14 that indicates visible light has not been applied, the controller 13 controls the lighting circuit 12 to light the lamp 11. Note that a state where visible light has not been applied does not only refer to a state where visible light has been completely blocked, but also refers to a state where the darkened environment is satisfied, that is, a state where the irradiance of visible light is less than 100 lx.

Furthermore, in order to apply ultraviolet rays L in the darkened environment, the ultraviolet rays L may be applied in the nighttime. FIG. 5 is a block diagram schematically illustrating another example of the configuration of the ultraviolet light source 1. The ultraviolet light source 1 includes a clock unit 15 and a storage unit 16.

The clock unit 15 has a function of detecting the current time, and includes, for example, an interface that receives the current time from a server (not illustrated) or the like, or a clock circuit. The storage unit 16 is constituted by a storage medium in which information relating to a time zone of the nighttime has been recorded. The time zone of the nighttime is, for example, a time zone from 6:00 p.m. to 6:00 a.m., a time zone from 7:00 p.m. to 5:00 a.m., or the like. The time zone of the nighttime may be defined for every month or every season, and may be defined from sunset time or sunrise time.

The controller 13 reads the information relating to the time zone from the storage unit 16, and determines whether the current time detected by the clock unit 15 is a time zone that has been defined as the nighttime. Then, in a case where the current time is the time zone that has been defined as the nighttime, the controller 13 controls the lighting circuit 12 to light the lamp 11. Note that the ultraviolet light source 1 may further include the detection unit 14 illustrated in FIG. 4.

Here, experiment results that specifically indicate functional effects of the present invention are described. A withering/killing experiment was conducted under Modes 1 to 6 described below, by using Salvinia molesta, which is a floating weed. Each of Modes 1 to 6 is indicated in Table 1, and results are indicated in Table 2.

TABLE 1

| | 222 nm | |
|---|---|---|
| | application state | Application environment |
| Mode 1 | Continuously apply | Darkened for 24 hours |
| | 222 nm 1 uW/cm² | |
| Mode 2 | Continuously apply | Apply visible light for 24 hours |
| | 222 nm 1 uW/cm² | (not darkened) |
| Mode 3 | Continuously apply | Apply visible light from 9:00 to |
| | 222 nm 1 uW/cm² | 18:00 darkened in the other time zone |
| Mode 4 | Absent | Darkened for 24 hours |
| Mode 5 | Absent | Apply visible light from 9:00 to |
| | | 18:00 darkened in the other time zone |
| Mode 6 | Absent | Apply visible light for 24 hours |
| | | (not darkened) |

TABLE 2

| Number of | | | | | | |
|---|---|---|---|---|---|---|
| elapsed days | Mode 1 | Mode 2 | Mode 3 | Mode 4 | Mode 5 | Mode 6 |
| 7th day | 20% had leaf | No leaf scorch | No leaf scorch | No leaf scorch | No leaf scorch | No leaf scorch |
| | scorch | | | | | |
| 14th day | 100% had leaf | 10% had leaf | 10% had leaf | No leaf scorch | No leaf scorch | 10% had leaf |
| | scorch | scorch | scorch | | | scorch |
| 21st day | Started | 20% had leaf | 25% had leaf | No leaf scorch | No leaf scorch | 20% had leaf |
| | withering | scorch | scorch | | | scorch |
| 28th day | Withered | 30% had leaf | 40% had leaf | No leaf scorch | No leaf scorch | 30% had leaf |
| | | scorch | scorch | | | scorch |

In Modes 1 to 3, as the ultraviolet light source 1, a KrCl excimer lamp that emits ultraviolet rays L having a peak wavelength of 222 nm was employed. Furthermore, in Modes 1 to 3, the ultraviolet rays L were continuously applied at an irradiance of 1 μW/cm².

In Mode 1, the darkened environment was kept for 24 hours a day. In Mode 2, visible light was applied for 24 hours a day (no darkened environment). In Mode 3, visible light was applied for 9 hours a day, 9:00 to 18:00, and the darkened environment was kept in the other time zone. Stated another way, Mode 1 simulates a state where ultraviolet rays are only applied in the darkened environment. Mode 2 simulates a state where ultraviolet rays are only applied in a non-darkened environment, and in other words, a state where ultraviolet rays are only applied in a time zone of the daytime. Mode 3 simulates a state where ultraviolet rays are applied in the darkened environment and the non-darkened environment, and in other words, a state where ultraviolet rays are applied regardless of the daytime or the nighttime.

For a comparison with Modes 1 to 3, in Modes 4 to 6, ultraviolet rays were not applied. Mode 4 corresponds to a state where ultraviolet rays are not applied in Mode 1, Mode 5 corresponds to a state where ultraviolet rays are not applied in Mode 3, and Mode 6 corresponds to a state where ultraviolet rays are not applied in Mode 2.

Visible light that was applied in Mode 2, Mode 3, Mode 5, and Mode 6 is light of neutral white LED illumination. Note that the darkened environment was achieved by covering Salvinia molesta with a shielding sheet.

A state of Salvinia molesta on each of the 7th day, the 14th day, the 21st day, the 28th day, and the 35th day was checked for each of Modes 1 to 6. As indicated in Table 2, in the case of Mode 1, approximately 20% entered into a leaf scorch state on the 7th day, approximately 100% entered into the leaf scorch state on the 14th day, and Salvinia molesta started withering on the 21st day. Moreover, Salvinia molesta completely withered on the 28th day. Therefore, by constantly keeping the darkened environment and applying ultraviolet rays, as indicated as Mode 1, Salvinia molesta can be withered/killed in a short period of time.

In the cases of Mode 2 and Mode 6, leaf scorch started from the 14th day, but it is guessed that this is because visible light was too strong and leaf scorch occurred. After that, a range of leaf scorch expanded, but Salvinia molesta did not wither. Furthermore, as is apparent from Mode 2 and Mode 5, in an environment where visible light is applied, a withering/killing effect of ultraviolet rays is not attained.

In the case of Mode 3, leaf scorch started from the 14th day, 25% had leaf scorch on the 21st day, and 40% had leaf scorch on the 28th day.

This indicates the following. If ultraviolet rays are applied in the nighttime, active oxygen that causes plants to be withered/killed is generated, and this advances the leaf scorch of the plants. However, after that, the plants perform photosynthesis in accordance with the application of visible light, and therefore active oxygen is annihilated or a component, such as chlorophyll, that contributes to photosynthesis is generated so that the plants are prevented from withering.

Stated another way, in the case of Mode 3, the advance and prevention of leaf scorch of the plants are repeatedly performed in a darkened state and a visible light application state, leaf scorch of the plants advances, and finally, the plants wither.

As indicated in Table 2, the experiment was finished on the 28th day, but it is obvious that the plants will wither if the experiment is continued after that.

Stated another way, as indicated as Mode 3, even if ultraviolet rays are applied in the nighttime, the plants can be withered/killed.

In the cases of Mode 4 and Mode 5, ultraviolet rays were not applied, and therefore leaf scorch did not occur, and the plants did not wither. Furthermore, as is apparent from a result of Mode 4, Salvinia molesta does not wither by simply keeping the darkened environment.

Furthermore, as other experiments, Another Experiment 1 and Another Experiment 2 described below were conducted, by using Amazon Frogbit, which is a floating weed. Conditions and results of Another Experiment 1 and Another Experiment 2 are indicated in Table 3.

TABLE 3

| | 222 nm | Application | 7 days (number |
|---|---|---|---|
| | application state | environment | of elapsed days) |
| Another | Continuously apply | Darkened for | Withered |
| Experiment 1 | 222 nm 10 uW/cm² | 24 hours | |
| Another | Continuously apply | Darkened for | Withered |
| Experiment 2 | 222 nm 100 uW/cm² | 24 hours | |

In Another Experiment 1 and Another Experiment 2, as the ultraviolet light source 1, a KrCl excimer lamp that emits ultraviolet rays L having a peak wavelength of 222 nm was employed. Furthermore, in Another Experiment 1, the ultraviolet rays L were continuously applied at an irradiance of 10 μW/cm², and in Another Experiment 2, the ultraviolet rays L were continuously applied at an irradiance of 100 μW/cm². In Another Experiment 1 and Another Experiment 2, the darkened environment was kept for 24 hours a day.

In Another Experiment 1 and Another Experiment 2, Amazon Frogpit withered on the 7th day. By setting the irradiance of ultraviolet rays to be applied to 10 μW/cm² or more, plants can be withered/killed in a very short period of time. Furthermore, as is apparent from results of Another Experiment 1 and Another Experiment 2, even in a case where a time zone of the darkened environment is short, as indicated as Mode 3 described above, and specifically, even in a case where ultraviolet rays are only applied in a time zone of the nighttime, there is a possibility that the withering/killing effect will be attained by setting the irradiance of ultraviolet rays to be applied to 10 μW/cm² or more.

### Second Embodiment

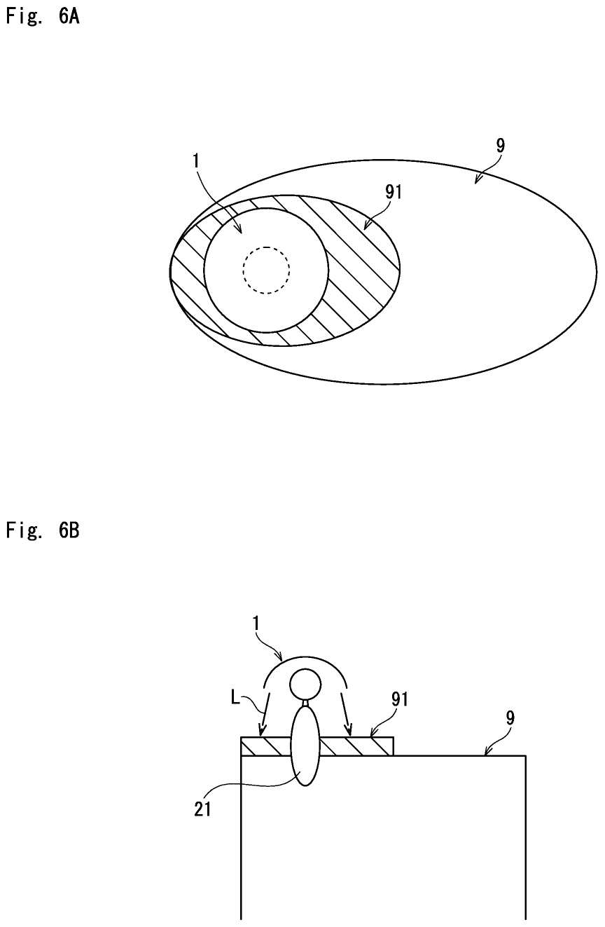

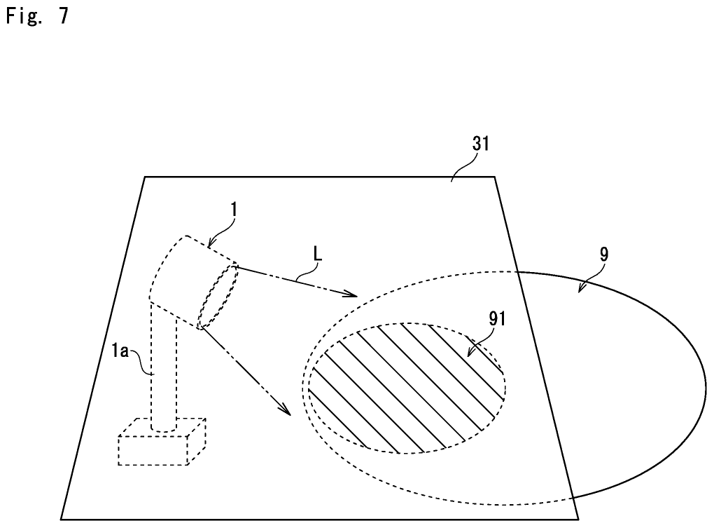

FIG. 6A and FIG. 6B are diagrams schematically illustrating another example of the situation where the plant withering/killing method according to the present invention is performed, FIG. 6A is a plan view, and FIG. 6B is a sectional view. In this example, the ultraviolet light source 1 has been floated in a plant presence area 91 of the pond 9.

The ultraviolet light source 1 includes a float 21 that floats on the water surface, as illustrated in FIG. 6B. The ultraviolet light source 1 that has been floated in the plant presence area 91 applies ultraviolet rays L to plants. In this example, the ultraviolet light source 1 is disposed near the plants, and therefore ultraviolet rays L having high irradiance can be applied. Furthermore, the ultraviolet light source 1 is configured to be movable on the water surface, and this can wither/kill plants in a wide range of the plant presence area 91. Note that as the other configuration of the ultraviolet light source 1, the configuration illustrated in FIG. 4 or the configuration illustrated in FIG. 5 can be employed.

### Third Embodiment

FIG. 7 is a diagram schematically illustrating yet another example of the situation where the plant withering/killing method according to the present invention is performed. In this example, the plant presence area 91 is covered with a light shielding tent 31, and ultraviolet rays L are applied to the plant presence area 91 from the ultraviolet light source 1 that is disposed inside the light shielding tent 31. Stated another way, in this example, the ultraviolet rays L are applied to the plant presence area 91 in a darkened environment formed by the light shielding tent 31.

### Fourth Embodiment

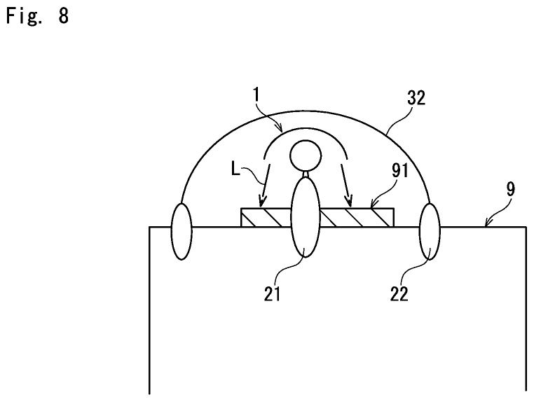

FIG. 8 is a diagram schematically illustrating yet another example of the situation where the plant withering/killing method according to the present invention is performed. In this example, the ultraviolet light source 1 that has been floated in the pond 9 is covered with a light shielding sheet 32. Stated another way, in this example, ultraviolet rays L are applied to the plant presence area 91 in a darkened environment formed by the light shielding sheet 32.

The light shielding sheet 32 includes a float 22 that floats on the water surface. Note that the light shielding sheet 32 may be mounted on the ultraviolet light source 1, and may float by using the float 21 of the ultraviolet light source 1, without including the float 22. Furthermore, the ultraviolet light source 1 may be mounted inside the light shielding sheet 32, and may float by using the float 22 of the light shielding sheet 32, without including the float 21.

The embodiments of the present invention have been described above with reference to the drawings, but it should be understood that specific configurations are not limited to these embodiments. The scope of the present invention is defined not only by the description of the embodiments described above but also by the claims, and includes the equivalents of the claims and all changes within the scope.

The structure adopted in each of the embodiments described above can be adopted in any other embodiment. A specific configuration of each component is not limited only to a configuration in the embodiments described above, and various variations can be made without departing from the spirit of the present invention. Moreover, one or more of the configurations, methods, or the like in the various modified examples described below may be arbitrarily selected, and may be employed as configurations, methods, or the like according to the embodiments described above.

For example, in the second embodiment illustrated in FIG. 6A and FIG. 6B, the plant presence area 91 may be covered with the light shielding tent 31, as illustrated in FIG. 7, and ultraviolet rays L may be applied to the plant presence area 91 inside the light shielding tent 31.

Furthermore, in the embodiments described above, as a light shielding means, the light shielding tent 31, as illustrated in FIG. 7, or the light shielding sheet 32 having a dome shape, as illustrated in FIG. 8, has been described. However, a configuration of the light shielding means is not particularly limited, if a target plant is covered and the darkened environment can be achieved.

In the embodiments described above, an example where ultraviolet rays are applied to plants that have propagated in the pond 9 and the plants are withered/killed has been described. However, the plant withering/killing method and the plant withering/killing system according to the present invention may aim at plants on land.

### DESCRIPTION OF REFERENCE SIGNS

1 Ultraviolet light source
4 Excimer lamp
5 Housing
6 Extraction portion
7 Optical filter
8 Electrode block
1a Pole
11 Lamp
12 Lighting circuit
13 Controller
14 Detection unit
15 Clock unit
16 Storage unit
21 Float
22 Float
31 Light shielding tent
32 Light shielding sheet
9 Pond
91 Plant presence area
L Ultraviolet rays

1. A plant withering/killing method comprising a process of applying ultraviolet rays to a plant from an ultraviolet light source, the ultraviolet rays having a peak wavelength within a wavelength range of 200 nm to 280 nm, wherein
the process of applying the ultraviolet rays is performed in a darkened environment.

2. The plant withering/killing method according to claim 1, wherein the process of applying the ultraviolet rays is performed in nighttime.

3. The plant withering/killing method according to claim 1, wherein the process of applying the ultraviolet rays is performed in a state where the plant is covered with light shielding means.

4. The plant withering/killing method according to claim 1, wherein the process of applying the ultraviolet rays is performed when a detection unit that enables visible light to be detected has not detected application of the visible light.

5. The plant withering/killing method according to claim 1, wherein
the ultraviolet light source includes a clock unit that detects current time, and
the process of applying the ultraviolet rays is performed when the current time detected by the clock unit is a time zone of nighttime.

6. The plant withering/killing method according to claim 3, wherein the ultraviolet light source is mounted inside the light shielding means.

7. The plant withering/killing method according to claim 3, wherein the light shielding means includes a float that floats on a water surface.

8. The plant withering/killing method according to claim 1, wherein the ultraviolet light source includes a float that floats on a water surface.

9. A plant withering/killing system comprising:
an ultraviolet light source that applies ultraviolet rays having a peak wavelength within a wavelength range of 200 nm to 280 nm; and
a controller that controls the ultraviolet light source to apply the ultraviolet rays to a plant in a darkened environment.

10. The plant withering/killing system according to claim 9, further comprising a detection unit that enables visible light to be detected, wherein
the controller controls the ultraviolet light source to light up, when the controller has received, from the detection unit, a signal indicating that application of the visible light has not been detected.

11. The plant withering/killing system according to claim 9, wherein
the ultraviolet light source includes a clock unit that detects current time, and a storage unit in which information relating to a time zone of nighttime has been recorded, and
the controller controls the ultraviolet light source to light up, when the current time detected by the clock unit is the time zone of the nighttime.
